(19) United States
(12) Patent Application Publication
(10) Pub. No.: US 2026/0211358 A1
(43) Pub. Date: Jul. 23, 2026

(54) FIXING DEVICE AND IMAGE FORMING APPARATUS

(71) Applicant: Ryohei MATSUDA, Kanagawa (JP)

(72) Inventor: Ryohei MATSUDA, Kanagawa (JP)

(73) Assignee: ETRIA Co., Ltd., Kanagawa (JP)

(21) Appl. No.: 19/345,241

(22) Filed: Sep. 30, 2025

(30) Foreign Application Priority Data
Jan. 17, 2025 (JP) 2025-006554

(51) Int. Cl. G03G 15/20

(52) U.S. Cl. CPC G03G 15/2025; G03G 15/2064; G03G 2215/2025

(57) ABSTRACT

A fixing device includes a fixing belt that rotates and a flange that supports a lateral end of the fixing belt in an axial direction thereof. The flange is applied with a lubricant between the flange and the fixing belt. The flange has an innermost edge that is oriented to a center of the fixing belt in the axial direction thereof. A heater is disposed within the fixing belt and radiates heat. A heat shield is disposed in proximity to the lateral end of the fixing belt in the axial direction thereof and interposed between the fixing belt and the heater. The heat shield has an outermost edge that is disposed in proximity to the lateral end of the fixing belt in the axial direction thereof. The outermost edge is disposed inboard from the innermost edge of the flange in the axial direction of the fixing belt.

### CROSS-REFERENCE TO RELATED APPLICATION

This patent application is based on and claims priority pursuant to 35 U.S.C. §119(a) to Japanese Patent Application No. 2025-006554, filed on January 17, 2025, in the Japan Patent Office, the entire disclosure of which is hereby incorporated by reference herein.

### BACKGROUND

### Technical Field

The present disclosure relates to a fixing device and an image forming apparatus, and more particularly, to a fixing device and an image forming apparatus incorporating the fixing device.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses include a fixing device that heats a recording medium such as a sheet that bears an unfixed image to fix the unfixed image on the recording medium. The fixing device includes a fixing sleeve and a heat shield. The fixing sleeve fixes the unfixed image on the recording medium. The heat shield suppresses temperature increase of a lateral end of the fixing sleeve in an axial direction thereof.

### SUMMARY

The present disclosure described herein provides a fixing device that includes a fixing belt that rotates and a flange that supports a lateral end of the fixing belt in an axial direction thereof. The flange is applied with a lubricant between the flange and the fixing belt. The flange has an innermost edge that is oriented to a center of the fixing belt in the axial direction thereof. A heater is disposed within the fixing belt and radiates heat. A heat shield is disposed in proximity to the lateral end of the fixing belt in the axial direction thereof and interposed between the fixing belt and the heater. The heat shield has an outermost edge that is disposed in proximity to the lateral end of the fixing belt in the axial direction thereof. The outermost edge is disposed inboard from the innermost edge of the flange in the axial direction of the fixing belt.

The present disclosure described herein further provides an image forming apparatus that includes an image forming device that forms an image and the fixing device described above that fixes the image on a recording medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an image forming apparatus according to an embodiment of the present disclosure;

FIG. 2 is a schematic cross-sectional view of a fixing device according to an embodiment of the present disclosure, that is incorporated in the image forming apparatus depicted in FIG. 1;

FIG. 3 is a perspective view of a reflector, a nip formation pad, and a fixing stay incorporated in the fixing device depicted in FIG. 2;

FIG. 4 is a diagram of the fixing device depicted in FIG. 2, illustrating a position of a heat shield incorporated in the fixing device;

FIG. 5 is a diagram of the heat shield and a flange incorporated in the fixing device depicted in FIG. 4 and a comparative heat shield;

FIG. 6 is a graph illustrating a relation between a distance between the flange and each of the heat shield and the comparative heat shield depicted in FIG. 5 and a temperature of the flange;

FIG. 7 is a graph illustrating a relation between a temperature of a hot plate and a number of fine particles that generate from a lubricant;

FIG. 8 is a diagram of a fixing device according to another embodiment of the present disclosure, that is installable in the image forming apparatus depicted in FIG. 1;

FIG. 9 is a diagram of a fixing device according to yet another embodiment of the present disclosure, that is installable in the image forming apparatus depicted in FIG. 1;

FIG. 10 is a diagram of a fixing device according to yet another embodiment of the present disclosure, that is installable in the image forming apparatus depicted in FIG. 1; and

FIG. 11 is a diagram of a fixing device according to yet another embodiment of the present disclosure, that is installable in the image forming apparatus depicted in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to drawings, the following describes embodiments of the present disclosure.

A description is provided of a construction of an image forming apparatus.

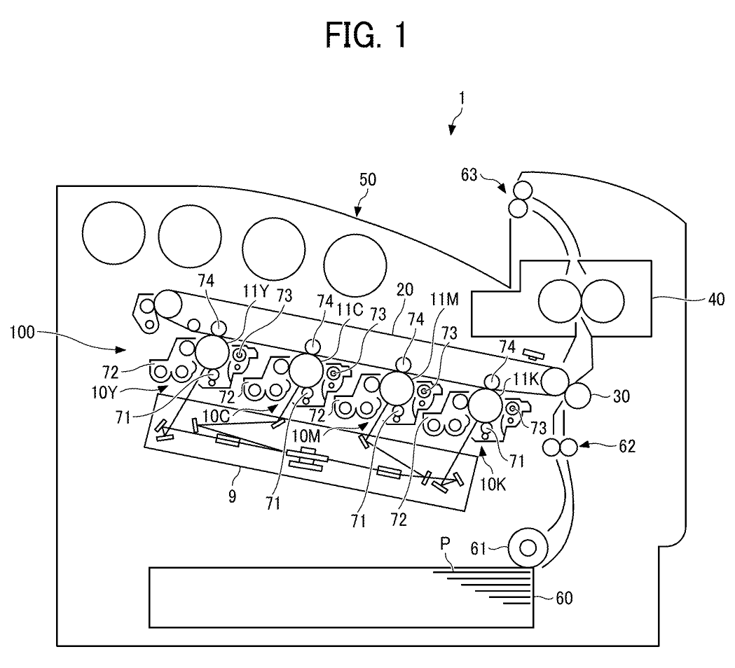

FIG. 1 is a schematic cross-sectional view of the image forming apparatus according to an embodiment of the present disclosure.

The image forming apparatus according to the embodiment is an image forming apparatus 1 employing an electrophotographic method as illustrated in FIG. 1.

The image forming apparatus 1 includes an image forming portion 100 that forms an image on a sheet P serving as a recording medium. The image forming portion 100 includes image forming devices 10Y, 10C, 10M, and 10K and an intermediate transfer belt 20. The image forming devices 10Y, 10C, 10M, and 10K form yellow (Y), cyan (C), magenta (M), and black (K) toner images, respectively. The image forming devices 10Y, 10C, 10M, and 10K are arranged in a rotation direction of the intermediate transfer belt 20 serving as an intermediate transferor. The image forming apparatus 1 is a tandem image forming apparatus that includes the image forming portion 100 including the components described above. The image forming devices 10Y, 10C, 10M, and 10K include photoconductors 11Y, 11C, 11M, and 11K serving as latent image bearers, respectively. Each of the image forming devices 10Y, 10C, 10M, and 10K further includes a charger 71 serving as a charging device, an optical writer 9 serving as an electrostatic latent image forming device, and a developing device 72 that surround each of the photoconductors 11Y, 11C, 11M, and 11K. Each of the image forming devices 10Y, 10C, 10M, and 10K further includes a primary transfer roller 74 serving as a primary transferor and a cleaning device 73 serving as a cleaner that surround each of the photoconductors 11Y, 11C, 11M, and 11K.

The charger 71 uniformly charges a surface of each of the photoconductors 11Y, 11C, 11M, and 11K at a predetermined electric potential. The optical writer 9 exposes the surface of each of the photoconductors 11Y, 11C, 11M, and 11K uniformly charged by the charger 71 according to image data, writing an electrostatic latent image on the surface of each of the photoconductors 11Y, 11C, 11M, and 11K. The developing devices 72 adhere toner in yellow, cyan, magenta, and black to the electrostatic latent images on the photoconductors 11Y, 11C, 11M, and 11K, respectively, developing the electrostatic latent images into yellow, cyan, magenta, and black toner images. The primary transfer rollers 74 transfer the yellow, cyan, magenta, and black toner images formed on the photoconductors 11Y, 11C, 11M, and 11K, respectively, onto the intermediate transfer belt 20. The cleaning devices 73 remove residual toner failed to be transferred onto the intermediate transfer belt 20 and therefore remaining on the photoconductors 11Y, 11C, 11M, and 11K therefrom, respectively, thus cleaning the photoconductors 11Y, 11C, 11M, and 11K.

The image forming apparatus 1 further includes a sheet tray 60, a pickup roller 61, a secondary transfer roller 30, and a registration roller pair 62. The sheet tray 60 is disposed below the image forming portion 100. The sheet tray 60 serves as a sheet supply that supplies sheets P loaded on the sheet tray 60. The pickup roller 61 is disposed above the sheet tray 60. The secondary transfer roller 30 is disposed opposite the intermediate transfer belt 20. The registration roller pair 62 is interposed between the pickup roller 61 and the secondary transfer roller 30.

The image forming apparatus 1 further includes an output roller pair 63, an output tray 50, and a fixing device 40. The output roller pair 63 and the output tray 50 are disposed in an upper portion of the image forming apparatus 1. The output roller pair 63 outputs the sheet P onto the output tray 50. The fixing device 40 is interposed between the secondary transfer roller 30 and the output roller pair 63. The fixing device 40 fixes a color toner image formed by the yellow, cyan, magenta, and black toner images superimposed on the sheet P under heat and pressure.

A description is provided of image forming operations performed by the image forming apparatus 1.

The charger 71 uniformly charges the surface of each of the photoconductors 11Y, 11C, 11M, and 11K at the predetermined electric potential. The optical writer 9 writes an electrostatic latent image on the surface of each of the photoconductors 11Y, 11C, 11M, and 11K according to image data. The developing devices 72 adhere toner in yellow, cyan, magenta, and black to the electrostatic latent images on the photoconductors 11Y, 11C, 11M, and 11K, respectively, developing the electrostatic latent images into yellow, cyan, magenta, and black toner images.

The primary transfer rollers 74 primarily transfer the yellow, cyan, magenta, and black toner images formed on the photoconductors 11Y, 11C, 11M, and 11K onto the intermediate transfer belt 20 such that the yellow, cyan, magenta, and black toner images are superimposed on the intermediate transfer belt 20. Thus, a color toner image is formed on the intermediate transfer belt 20. As the intermediate transfer belt 20 rotates, the color toner image formed on the intermediate transfer belt 20 is conveyed to a secondary transfer region (e.g., a secondary transfer nip) where the intermediate transfer belt 20 is disposed opposite the secondary transfer roller 30.

The pickup roller 61 picks up and feeds the sheets P placed on the sheet tray 60 one by one. The image forming apparatus 1 further includes a conveyance path. The registration roller pair 62 conveys the sheet P sent from the sheet tray 60 through the conveyance path to the secondary transfer region at a predetermined time.

The secondary transfer roller 30 secondarily transfers the color toner image formed on the intermediate transfer belt 20 onto the sheet P conveyed to the secondary transfer region. Thereafter, the sheet P transferred with the color toner image is conveyed to the fixing device 40.

While the fixing device 40 heats the sheet P transferred with the color toner image, the fixing device 40 applies pressure to the sheet P, fixing the color toner image on the sheet P.

The sheet P bearing the fixed color toner image is conveyed through the conveyance path. The output roller pair 63 ejects the sheet P onto the output tray 50.

A description is provided of a construction of the fixing device 40.

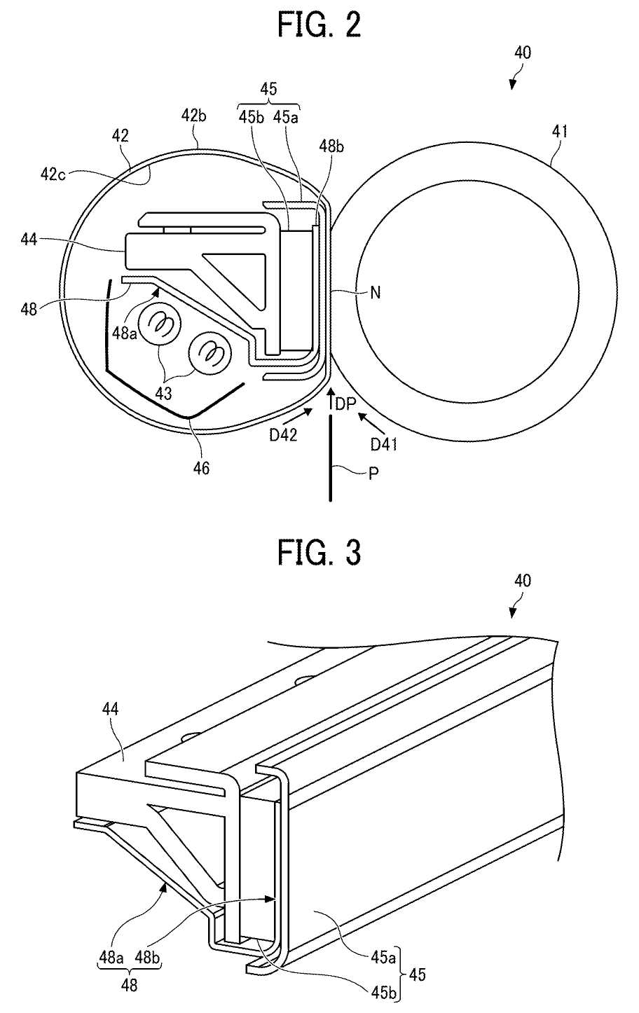

FIG. 2 is a schematic cross-sectional view of the fixing device 40 according to an embodiment of the present disclosure depicted in FIG. 1.

As illustrated in FIG. 2, the fixing device 40 according to the embodiment includes a pressure roller 41, a fixing belt 42, and a heater 43. While the fixing device 40 heats the sheet P, the fixing device 40 applies pressure to the sheet P, fixing the color toner image on the sheet P.

The pressure roller 41 serves as one example of a pressure rotator according to the embodiment. The pressure roller 41 is disposed opposite an outer circumferential face 42b of the fixing belt 42. The pressure roller 41 includes a metal roller, a silicone rubber layer, and a release layer. The silicone rubber layer is mounted on an outer periphery of the metal roller. The release layer is disposed on a surface of the silicone rubber layer. The release layer facilitates separation of the sheet P from the pressure roller 41. The release layer is made of perfluoroalkoxy alkane (PFA) or polytetrafluoroethylene (PTFE). The fixing device 40 further includes a spring or the like that presses the pressure roller 41 against the fixing belt 42. As the spring presses and deforms the silicone rubber layer of the pressure roller 41, the pressure roller 41 and the fixing belt 42 form a fixing nip N therebetween. The fixing nip N has a predetermined nip width in a sheet conveyance direction DP. The image forming apparatus 1 further includes a driver such as a motor that generates a driving force. As the driving force is transmitted to the pressure roller 41 through a gear, the pressure roller 41 rotates in a rotation direction D41. The pressure roller 41 may be a solid roller or a hollow roller. However, the hollow roller preferably has a decreased thermal capacity. Alternatively, a heater such as a halogen heater may be disposed inside the pressure roller 41. The silicone rubber layer may be made of solid rubber. Alternatively, if no heater is disposed inside the pressure roller 41, the silicone rubber layer may be made of sponge rubber. The sponge rubber enhances thermal insulation of the pressure roller 41, preferably causing the pressure roller 41 to draw less heat from the fixing belt 42.

The fixing belt 42 serves as one example of a fixing sleeve according to the embodiment. The fixing belt 42 is disposed opposite the pressure roller 41. As the fixing belt 42 receives the driving force from the pressure roller 41 at the fixing nip N, the fixing belt 42 rotates in a rotation direction D42 in accordance with rotation of the pressure roller 41. Thus, the pressure roller 41 and the fixing belt 42 apply pressure to the sheet P conveyed through the fixing nip N formed between an outer circumferential face of the pressure roller 41 and the outer circumferential face 42b of the fixing belt 42.

The fixing belt 42 is an endless belt or film that includes a base layer made of metal such as nickel and stainless used steel (SUS) or resin such as polyimide. The fixing belt 42 further includes a release layer serving as a surface layer made of PFA, PTFE, or the like, facilitating separation of toner of the toner image on the sheet P from the fixing belt 42 and preventing the toner from adhering to the fixing belt 42.

The fixing belt 42 may further include an elastic layer that is made of silicone rubber or the like and interposed between the base layer and the release layer. If the fixing belt 42 does not incorporate the elastic layer, the fixing belt 42 attains a decreased thermal capacity that improves a fixing property of being heated quickly. However, when the pressure roller 41 presses an unfixed toner image to fix the unfixed toner image on the sheet P, slight surface asperities of the fixing belt 42 may be transferred onto the toner image, causing a failure that an orange peel mark remains on a solid part of the toner image. To address the circumstance, the elastic layer has a thickness of 100 µm or more. As the elastic layer deforms, the elastic layer absorbs the slight surface asperities, preventing the orange peel mark on the toner image.

The fixing device 40 further includes a fixing stay 44 and a nip formation pad 45 that are disposed within a loop formed by the fixing belt 42. The fixing stay 44 serves as a stay that supports the nip formation pad 45.

The nip formation pad 45 includes a thermal equalizer 45a and a resin pad 45b. The thermal equalizer 45a is disposed opposite the fixing nip N. The resin pad 45b supports the thermal equalizer 45a. The resin pad 45b performs thermal insulation as one function thereof. The resin pad 45b suppresses conduction of heat from the fixing belt 42 to the fixing stay 44 through the nip formation pad 45, suppressing increase of a warm-up time and a typical electricity consumption (TEC).

The thermal equalizer 45a serves as one example of a slide aid according to the embodiment. The thermal equalizer 45a also serves as a thermal conductor. For example, the thermal equalizer 45a is a pad that extends in a longitudinal direction of the fixing belt 42. As the thermal equalizer 45a contacts an inner circumferential face 42c of the fixing belt 42, that slides over the thermal equalizer 45a, the thermal equalizer 45a equalizes a temperature of the fixing belt 42 in an axial direction (e.g., the longitudinal direction) thereof. For example, the thermal equalizer 45a draws heat from an increased temperature portion of the fixing belt 42, that has an increased temperature, and conducts the drawn heat to a decreased temperature portion of the fixing belt 42, that has a decreased temperature, thus attaining even temperature across the fixing belt 42 in the axial direction thereof. As illustrated in FIG. 2, the fixing nip N is planar. Alternatively, the fixing nip N may be recessed or concave or may have other shapes. If the fixing nip N is recessed, the fixing nip N directs a leading edge of the sheet P to the pressure roller 41 when the sheet P is ejected from the fixing nip N in the sheet conveyance direction DP, facilitating separation of the sheet P from the fixing belt 42 and thereby preventing the sheet P from being jammed.

The thermal equalizer 45a is made of metal, such as aluminum and copper, having an enhanced thermal conductivity of 50 [W/m·K] or more. A surface of the thermal equalizer 45a is treated with a coating that facilitates sliding of the fixing belt 42 over the thermal equalizer 45a. The coating is made of resin-based materials such as polyimide resin, fluororesin, polyphenylene sulfide resin, and saturated polyester resin. The resin-based coating may be mixed with glass fibers, carbon, graphite, graphite fluoride, carbon fibers, molybdenum disulfide, fluororesin, and the like.

The coating may be made of metal-based materials. The metal-based coating may be made of molybdenum disulfide, nickel, composite plating of nickel and fluororesin, and the like. Alternatively, the metal-based coating may be made of alumite or alumite impregnated with resin or metal. The coating may be made of ceramics. The ceramics used as the coating include silicon carbide ceramic, silicon nitride ceramic, alumina ceramic, and those mixed with molybdenum disulfide, fluororesin, and the like.

The thermal equalizer 45a may include an alumite layer as a surface layer. The alumite layer is made of aluminum or an aluminum alloy. The alumite layer may include micro pores filled with molybdenum disulfide produced via secondary electrolysis from a bottom-most portion to an outermost layer (e.g., a surface layer) of each of the micro pores.

The fixing stay 44 is a hollow metal pipe made of metal such as aluminum, iron, and stainless steel. According to the embodiment, the fixing stay 44 has substantially right-angled corners. Alternatively, the fixing stay 44 may have other shapes in cross section. The fixing stay 44 prevents the nip formation pad 45 from being bent by pressure from the pressure roller 41, attaining a uniform nip width of the fixing nip N in the sheet conveyance direction DP throughout an entire span of the fixing belt 42 in the axial direction thereof.

The fixing device 40 further includes a heat shield 46 that is disposed within the loop formed by the fixing belt 42. The heat shield 46 is made of metal that has an increased heat resistance and an increased thermal conductivity, for example, SUS, aluminum, copper, or the like. The heat shields 46 are disposed in proximity to both lateral ends of the fixing belt 42 in the axial direction thereof, respectively, and interposed between the heater 43 and the fixing belt 42. Thus, the heat shields 46 suppress conduction of heat from the heater 43 to the fixing belt 42, suppressing temperature increase in lateral end regions in proximity to both lateral ends of the fixing belt 42 in the axial direction thereof.

The heater 43 serves as one example of a heater according to the embodiment. For example, the heater 43 is a halogen heater.

The fixing device 40 includes two heaters 43 that are disposed within the loop formed by the fixing belt 42. The two heaters 43 extend in parallel with each other in the axial direction of the fixing belt 42. The heaters 43 are disposed opposite the inner circumferential face 42c of the fixing belt 42 and heat the fixing belt 42 directly with radiant heat. Alternatively, the heater that heats the fixing belt 42 may be an induction heating (IH) coil, a resistive heat generator, a carbon heater, or the like.

The fixing device 40 further includes a reflector 48 that is disposed within the loop formed by the fixing belt 42. The reflector 48 decreases loss of radiant heat generated by the heaters 43. The reflector 48 serves as one example of a reflector according to the embodiment. The reflector 48 disposed within the loop formed by the fixing belt 42 reflects radiant heat from the heaters 43 toward the inner circumferential face 42c of the fixing belt 42. The reflector 48 is made of high-luminance aluminum or the like. The reflector 48 includes a base and a surface layer. The base is made of metal such as high-purity aluminum. The surface layer includes a plurality of high-reflection coatings and a protective overcoat. Alternatively, the reflector 48 may include an aluminum sheet or the like evaporated with silver to improve reflectance.

The reflector 48 according to the embodiment includes a reflecting portion 48a and a pressure receiving portion 48b. The reflecting portion 48a is interposed between the heaters 43 and the fixing stay 44. The reflecting portion 48a reflects radiant heat from the heaters 43 toward the inner circumferential face 42c of the fixing belt 42. The pressure receiving portion 48b is sandwiched between the thermal equalizer 45a and the resin pad 45b. The pressure receiving portion 48b receives pressure from the pressure roller 41.

FIG. 3 is a perspective view of the reflector 48, the nip formation pad 45, and the fixing stay 44 depicted in FIG. 2.

As illustrated in FIG. 3, the thermal equalizer 45a and the resin pad 45b sandwich the pressure receiving portion 48b, thus supporting the reflector 48. A portion of the reflector 48, that is other than the pressure receiving portion 48b, does not contact other components of the fixing device 40, that are other than the reflector 48.

The reflector 48 includes the pressure receiving portion 48b that is sandwiched between the thermal equalizer 45a and the resin pad 45b and extended in a pressure receiving region where the pressure receiving portion 48b receives pressure from the pressure roller 41. The reflector 48 is made of metal having an enhanced thermal conductivity such as aluminum. Hence, heat absorbed by the reflecting portion 48a conducts through an entirety of the reflector 48 quickly. Accordingly, the pressure receiving portion 48b contacting the thermal equalizer 45a conducts heat absorbed by the reflector 48 to the thermal equalizer 45a, suppressing temperature increase of the reflector 48. Heat conducted from the reflector 48 to the thermal equalizer 45a is conducted to the fixing belt 42 through the thermal equalizer 45a and is used to melt toner of the toner image on the sheet P. Accordingly, compared to a configuration in which the reflector 48 dissipates heat to other components such as the fixing stay 44, the fixing device 40 utilizes heat conducted to the reflector 48 effectively, shortening an energization time of the heaters 43 and reducing power consumption of the heaters 43.

The pressure receiving portion 48b is disposed in the pressure receiving region where the pressure receiving portion 48b receives pressure from the pressure roller 41. Accordingly, the thermal equalizer 45a contacts the pressure receiving portion 48b more closely, increasing thermal conduction and improving efficiency of the reflector 48 that dissipates heat. The thermal equalizer 45a and the reflector 48 are made of metal having an increased thermal conductivity. Thus, the reflector 48 dissipates heat to the fixing belt 42 efficiently.

As illustrated in FIGS. 2 and 3, the reflector 48 separates from a bent portion of the thermal equalizer 45a and the fixing stay 44 with a clearance therebetween. Accordingly, the reflector 48 prevents conduction of heat to the bent portion of the thermal equalizer 45a and the fixing stay 44 that do not utilize heat effectively.

The fixing device 40 having the above-described construction suppresses temperature increase of the reflector 48 and utilizes heat conducted to the reflector 48 effectively, suppressing power consumption.

As described above, the thermal equalizer 45a is treated with the coating that facilitates sliding of the fixing belt 42 over the thermal equalizer 45a. A coefficient of friction of the thermal equalizer 45a with respect to the inner circumferential face 42c of the fixing belt 42 is smaller than a coefficient of friction of a surface of the pressure receiving portion 48b with respect to the inner circumferential face 42c of the fixing belt 42. Accordingly, compared to a configuration in which the pressure receiving portion 48b of the reflector 48 contacts the inner circumferential face 42c of the fixing belt 42 and the reflector 48 dissipates heat to the fixing belt 42 without the thermal equalizer 45a between the reflector 48 and the fixing belt 42, the thermal equalizer 45a decreases sliding friction of the fixing belt 42 that slides over the thermal equalizer 45a. Consequently, the thermal equalizer 45a suppresses increase of torque that generates to rotate the fixing belt 42 and suppresses abrasion of the inner circumferential face 42c of the fixing belt 42.

A configuration in which the pressure receiving portion 48b of the reflector 48 is treated with a coating that facilitates sliding of the fixing belt 42 and the pressure receiving portion 48b contacts the inner circumferential face 42c of the fixing belt 42 may cause failures described below. For example, if the coating that facilitates sliding of the fixing belt 42 adheres to the reflecting portion 48a of the reflector 48, a reflectance of the reflecting portion 48a may decrease. To address the circumstance, for example, the reflecting portion 48a is treated with masking or the like to prevent the coating that facilitates sliding of the fixing belt 42 from adhering to the reflecting portion 48a. Treating the reflecting portion 48a with masking generates a process for applying a masking to the reflecting portion 48a, a process for peeling off the masking, a process for removing an adhesive of the masking adhered to the reflecting portion 48a, and the like. The processes are performed with machines or the like with production complexity. Even if the processes are performed with the machines properly, manufacturing costs may increase.

Conversely, the fixing device 40 according to the embodiment includes the thermal equalizer 45a through which heat is conducted from the reflector 48 to the fixing belt 42. Hence, the reflector 48 does not have a function that facilitates sliding of the inner circumferential face 42c of the fixing belt 42 over the reflector 48. Accordingly, the pressure receiving portion 48b is not treated with the coating that facilitates sliding of the fixing belt 42 over the reflector 48, suppressing production complexity and manufacturing costs.

According to the embodiment, the thermal equalizer 45a is interposed between the pressure receiving portion 48b of the reflector 48 and the fixing belt 42. However, a component interposed between the pressure receiving portion 48b and the fixing belt 42 is not limited as long as the component facilitates sliding of the inner circumferential face 42c of the fixing belt 42 more than the reflector 48. For example, the fixing device 40 may include a slide sheet although the slide sheet degrades dissipation of heat to the fixing belt 42 compared to the thermal equalizer 45a. The slide sheet serves as a slide aid that is interposed between the pressure receiving portion 48b and the fixing belt 42. The slide sheet is made of fiber such as PTFE impregnated with a lubricant such as silicone oil. For example, the slide sheet is wrapped around the resin pad 45b and the pressure receiving portion 48b. The slide sheet is fastened to a back face of the resin pad 45b, that faces the fixing stay 44, with a screw or the like.

A description is provided of a construction of a comparative fixing device.

The comparative fixing device includes a fixing belt, a heater, a belt support, and a shield. The fixing belt is rotatably supported. The heater heats the fixing belt. The belt support supports a lateral end of the fixing belt in a longitudinal direction thereof. The shield blocks heat conducted from the heater. The shield includes a first heat shielding plate and a second heat shielding plate. The first heat shielding plate is disposed opposite the heater and the fixing belt. The second heat shielding plate is disposed opposite the belt support. The first heat shielding plate and the second heat shielding plate are arranged with a clearance therebetween to suppress conduction of heat between the first heat shielding plate and the second heat shielding plate. Thus, the shield suppresses temperature increase of the belt support.

The belt support supporting the lateral end of the fixing belt (e.g., a fixing sleeve) in the longitudinal direction thereof is adhered with a lubricant such as oil to improve sliding of an inner circumferential face of the fixing belt. As the temperature of the belt support increases, the lubricant may evaporate and generate fine particles. For example, the first heat shielding plate and the second heat shielding plate that receive heat from the heater constantly are subject to substantial temperature increase. The first heat shielding plate and the second heat shielding plate are disposed in proximity to the belt support that supports the fixing belt. Hence, the first heat shielding plate and the second heat shielding plate may cause the fine particles to generate easily.

To address the circumstance, in the comparative fixing device incorporating the heater that heats the fixing belt, suppression of temperature increase of the belt support that supports the lateral end of the fixing belt in the longitudinal direction thereof is requested.

A description is provided of a position of the heat shield 46 in the axial direction of the fixing belt 42.

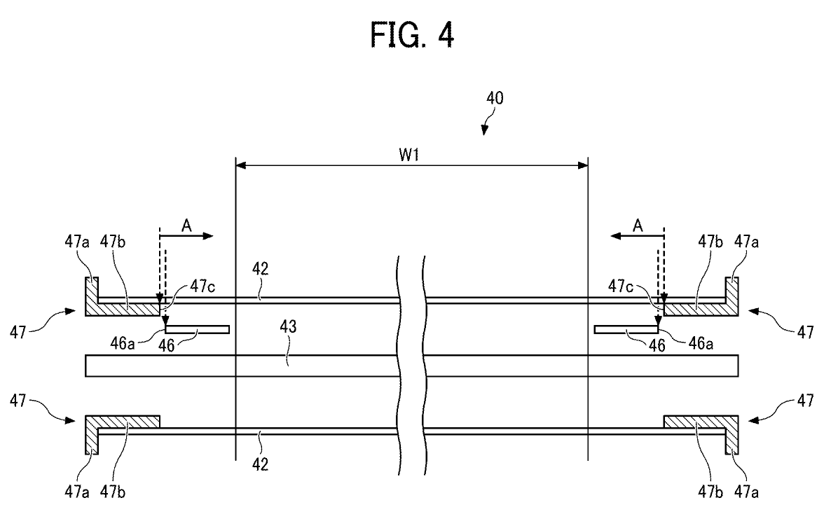

FIG. 4 is a diagram of the fixing device 40, illustrating the position of the heat shield 46 inside the fixing device 40 depicted in FIG. 2. FIG. 4 illustrates the position of the heat shield 46 seen in a direction perpendicular to the axial direction of the fixing belt 42. In order to clarify the description of the position of the heat shield 46, FIG. 4 illustrates the single heater 43 and omits illustration of the fixing stay 44, the nip formation pad 45, and the reflector 48.

As illustrated in FIG. 4, the fixing device 40 according to the embodiment further includes flanges 47 that support both lateral ends of the fixing belt 42 in the axial direction thereof, respectively.

The flange 47 serves as one example of a support flange according to the embodiment. The flange 47 includes a ring 47a and a tube 47b. The ring 47a is a ring-shaped member having a through hole. The tube 47b is tubular and has one end that adjoins an inner circumference of the ring 47a.

As the tube 47b of the flange 47 is fitted within the fixing belt 42 at the lateral end of the fixing belt 42 in the axial direction thereof, the flange 47 supports the lateral end of the fixing belt 42 in the axial direction thereof. The ring 47a covers an edge face of the fixing belt 42 in the axial direction thereof.

As described above, the heat shields 46 are disposed in proximity to both lateral ends of the fixing belt 42 in the axial direction thereof, respectively, and interposed between the fixing belt 42 and the heater 43. The heat shields 46 are disposed outboard from a sheet conveyance region W1 (e.g., a sheet conveyance span) in the axial direction of the fixing belt 42. The sheet P is conveyed over the outer circumferential face 42b of the fixing belt 42 in the sheet conveyance region W1. According to the embodiment, the heat shield 46 includes an outermost edge 46a that is disposed in proximity to the lateral end of the fixing belt 42 in the axial direction thereof. The flange 47 includes an innermost edge 47c that is oriented to a center of the fixing belt 42 in the axial direction thereof. The outermost edge 46a of the heat shield 46 is disposed inboard from the innermost edge 47c of the flange 47 in the axial direction of the fixing belt 42, that is, a direction A.

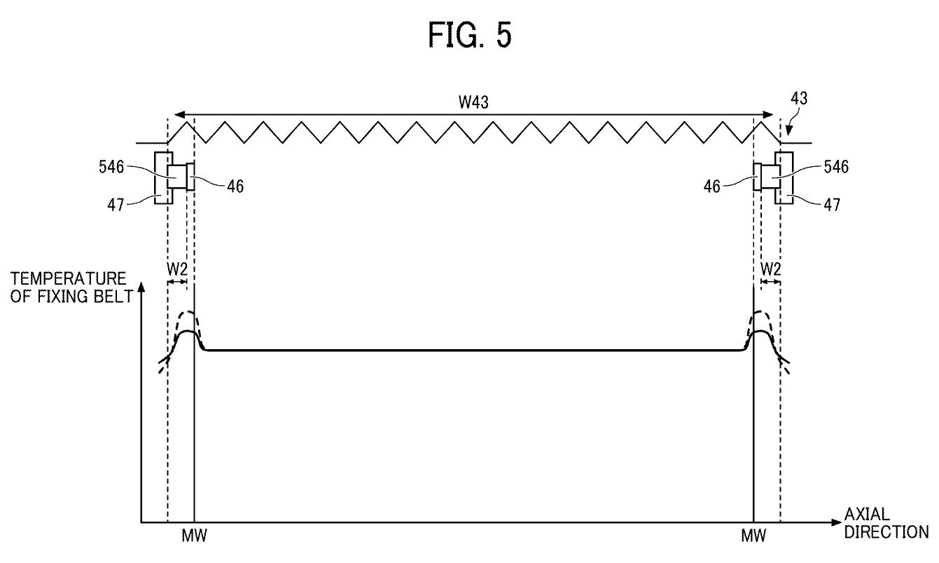

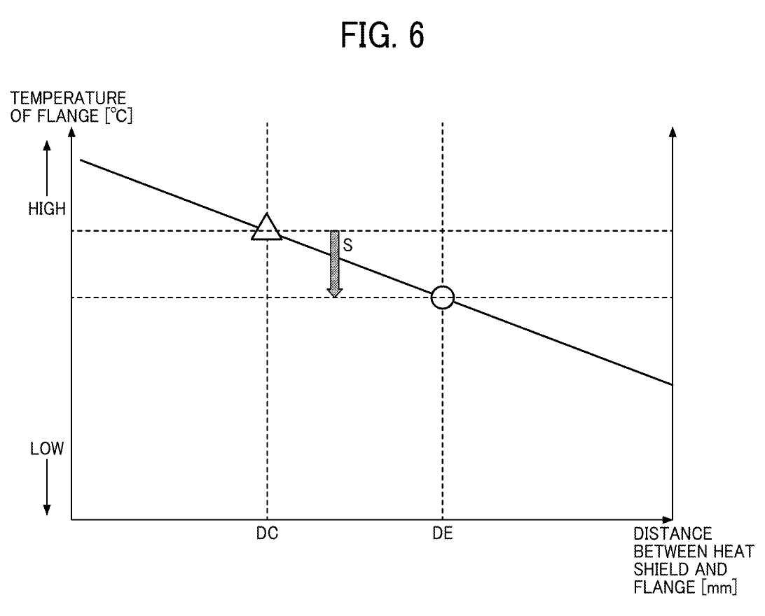

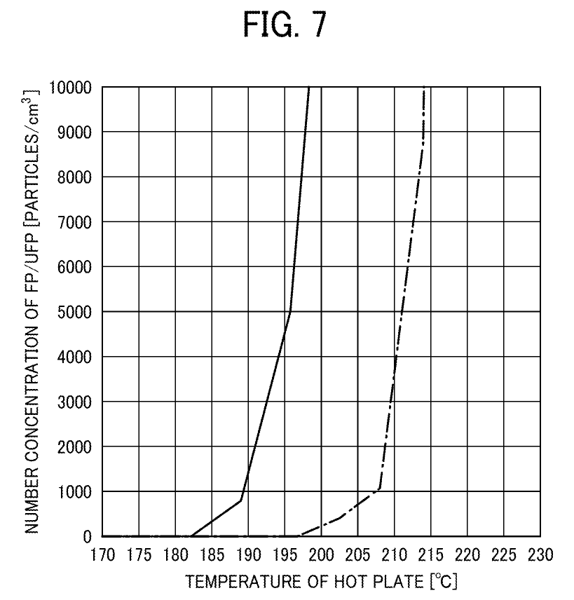

FIGS. 5 and 6 are diagrams that illustrate advantages of the fixing device 40 according to the embodiment, respectively. FIG. 7 is a graph illustrating a relation between a temperature and a number of fine particles that generate from a lubricant. FIG. 7 illustrates x-axis that represents a temperature of a hot plate in degrees Celsius and y-axis that represents a number concentration of fine particles (FP) and ultrafine particles (UFP) per cubic centimeter.

The heat shields 46 are disposed in proximity to both lateral ends of the fixing belt 42 in the axial direction thereof, respectively. When a plurality of sheets P is conveyed through the sheet conveyance region W1 depicted in FIG. 4 continuously, both outboard regions (e.g., the lateral end regions) disposed outboard from the sheet conveyance region W1 in the axial direction of the fixing belt 42 may suffer from temperature increase because the plurality of sheets P does not draw heat from the outboard regions on the fixing belt 42. The heat shields 46 suppress temperature increase of the outboard regions on the fixing belt 42, respectively. A length of the heat shield 46 in the axial direction of the fixing belt 42 is designed to suppress temperature increase of the outboard region on the fixing belt 42. The heat shield 46 is positioned with respect to the flange 47 in the axial direction of the fixing belt 42.

FIG. 5 illustrates a heat shield 546 that has a width W2 and partially overlaps the flange 47 in the axial direction of the fixing belt 42. In this case, radiant heat generated by the heater 43 in a heat generation region W43 is conducted to the flange 47 through the heat shield 546 easily. The heat generation region W43 is a heat generation span defined by a heater width of the heater 43 in the axial direction of the fixing belt 42. FIG. 5 illustrates outermost edges MW of a sheet P having a maximum width in the axial direction of the fixing belt 42, that is available in the fixing device 40. The flange 47 is adhered with a lubricant such as oil to improve sliding of the inner circumferential face 42c of the fixing belt 42 over the flange 47. As the temperature of the flange 47 increases, the lubricant may evaporate and generate fine particles.

Conversely, according to the embodiment, the reflector 48 made of metal that conducts heat from the heater 43 easily contacts the thermal equalizer 45a made of metal that attains even temperature across the fixing belt 42 in the axial direction thereof. Hence, the reflector 48 ensures a uniform temperature profile indicated with a solid line in FIG. 5 of the fixing belt 42 in the axial direction thereof, that contacts and slides over the thermal equalizer 45a, compared to a comparative temperature profile indicated with a broken line in FIG. 5. If a thermal conductivity of the reflector 48 is greater than a thermal conductivity of the heat shield 46, the reflector 48 improves the uniform temperature profile in the axial direction of the fixing belt 42 further.

Accordingly, as illustrated in FIGS. 4 and 5, the outermost edge 46a of the heat shield 46, that is disposed in proximity to the lateral end of the fixing belt 42 in the axial direction thereof, is disposed inboard from the innermost edge 47c of the flange 47, that is oriented to the center of the fixing belt 42 in the axial direction of the fixing belt 42. Thus, a distance between the heat shield 46 and the flange 47 is greater than a distance between the heat shield 546 as a comparative heat shield and the flange 47.

FIG. 6 illustrates x-axes that represent a distance between a heat shield (e.g., the heat shields 546 and 46) and the flange 47 and y-axis that represents a temperature of the flange 47. FIG. 6 illustrates a distance DC between the heat shield 546 as the comparative heat shield and the flange 47 and a distance DE between the heat shield 46 according to the embodiment and the flange 47. As illustrated in FIG. 6, a temperature of the flange 47 indicated with a circle in FIG. 6 is lower than a temperature of the flange 47 indicated with a triangle in FIG. 6. The temperature indicated with the triangle is obtained with a decreased distance between the heat shield 546 and the flange 47. The temperature indicated with the circle in FIG. 6 is obtained with an increased distance between the heat shield 46 and the flange 47. FIG. 6 illustrates suppression of an amount of temperature increase of the flange 47 in degrees Celsius with a bold downward arrow S. Air between the heat shield 46 and the flange 47 enhances thermal insulation, suppressing conduction of radiant heat from the heater 43 to the flange 47 through the heat shield 46.

Radiant heat generated by the heater 43 is not conducted to the flange 47 through the heat shield 46 easily. Accordingly, as illustrated in FIG. 7, the heat shield 46 decreases fine particles generated from fluorinated grease, silicone oil, and the like. FIG. 7 illustrates a number concentration of the fluorinated grease with a solid curve and a number concentration of the silicone oil with a broken curve.

A description is provided of a construction of a fixing device 40A according to another embodiment of the present disclosure.

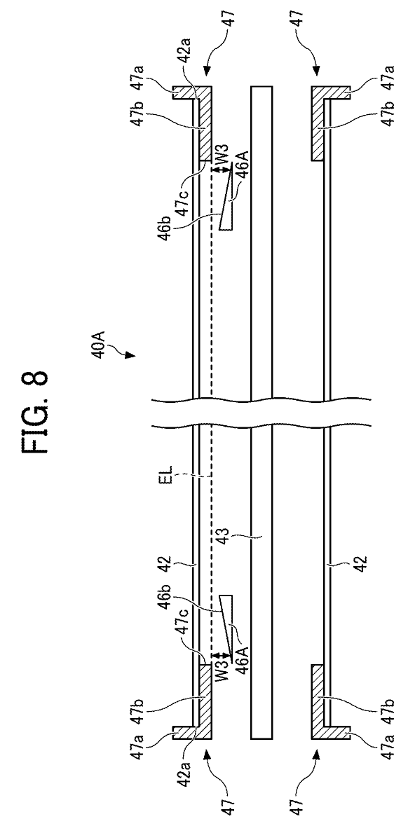

FIG. 8 is a diagram of the fixing device 40A according to the another embodiment of the present disclosure. FIG. 8 illustrates components of the fixing device 40A seen in the direction perpendicular to the axial direction of the fixing belt 42. In order to clarify the description of the construction of the fixing device 40A, FIG. 8 illustrates the single heater 43 depicted in FIG. 2 and omits illustration of the fixing stay 44, the nip formation pad 45, and the reflector 48.

As illustrated in FIG. 8, the fixing device 40A according to the embodiment includes a heat shield 46A that is different from the heat shield 46 depicted in FIG. 4 in shape. The heat shield 46A according to the embodiment has a right-angled triangle shape when seen in the direction perpendicular to the axial direction of the fixing belt 42. The heat shield 46A includes a slope 46b of a right-angled triangle. The innermost edge 47c of the flange 47 disposed opposite one lateral end of the fixing belt 42 and the innermost edge 47c of the flange 47 disposed opposite another lateral end of the fixing belt 42 define an extension line EL therebetween in the axial direction of the fixing belt 42. The slope 46b and the extension line EL define a clearance W3 therebetween in the direction perpendicular to the axial direction of the fixing belt 42. The clearance W3 increases toward a lateral edge 42a of the fixing belt 42 in the axial direction thereof. For example, the heat shield 46A according to the embodiment has a shape that separates from the flange 47 farther toward the lateral edge 42a of the fixing belt 42 in the axial direction thereof.

Accordingly, as a distance between the heat shield 46A and the flange 47 increases, according to a relation between a distance between the heat shield 46 and the flange 47 and a temperature increase of the flange 47 depicted in FIG. 6, the heat shield 46A suppresses temperature increase of the flange 47. Consequently, as illustrated in FIG. 7, the heat shield 46A suppresses generation of the fine particles.

According to the embodiment, the heat shield 46A includes the slope 46b of the right-angled triangle. The innermost edge 47c of the flange 47 disposed opposite one lateral end of the fixing belt 42 and the innermost edge 47c of the flange 47 disposed opposite another lateral end of the fixing belt 42 define the extension line EL therebetween in the axial direction of the fixing belt 42. The slope 46band the extension line EL define the clearance W3 therebetween in the direction perpendicular to the axial direction of the fixing belt 42. The clearance W3 increases toward the lateral edge 42a of the fixing belt 42 in the axial direction thereof. Alternatively, the platy heat shield 46 may be inclined. Thus, the clearance W3 between the extension line EL, that is extended from the innermost edge 47c of the flange 47 disposed opposite one lateral end of the fixing belt 42 to the innermost edge 47c of the flange 47 disposed opposite another lateral end of the fixing belt 42 in the axial direction of the fixing belt 42, and the heat shield 46 increases toward the lateral edge 42a of the fixing belt 42 in the axial direction thereof.

A description is provided of a construction of a fixing device 40B according to yet another embodiment of the present disclosure.

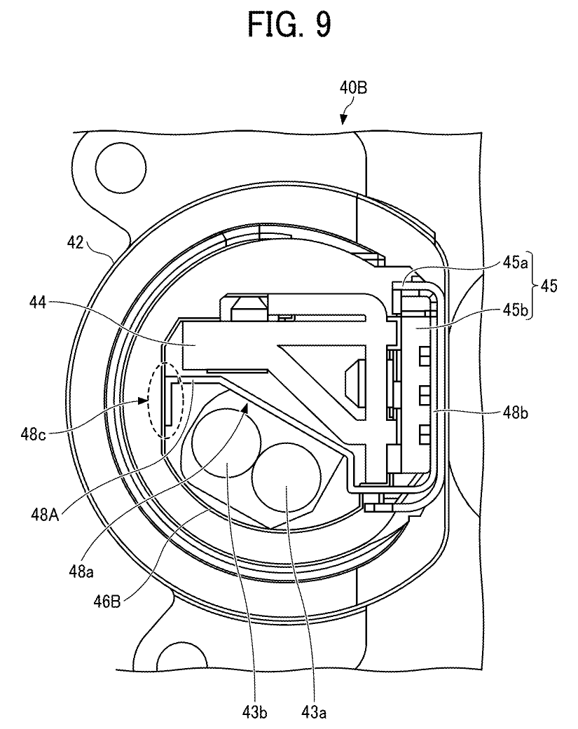

FIG. 9 is a cross-sectional view of the fixing device 40B according to the yet another embodiment of the present disclosure. FIG. 9 illustrates components of the fixing device 40B seen in the axial direction of the fixing belt 42. In order to clarify the description of the construction of the fixing device 40B, FIG. 9 omits illustration of the pressure roller 41 and the flange 47.

As illustrated in FIG. 9, the fixing device 40B according to the embodiment includes a heat shield 46B and a reflector 48A. The heat shield 46B is different from the heat shield 46 depicted in FIG. 2 in that the heat shield 46B is in contact with and thermally coupled with a coupling portion 48c of the reflector 48A. The heaters 43 include a center heater 43a and a lateral end heater 43b. The center heater 43a is disposed opposite a center span of the fixing belt 42 in the axial direction thereof. The lateral end heater 43b is disposed opposite lateral end spans of the fixing belt 42 in the axial direction thereof.

With the construction of the fixing device 40B described above, the reflector 48A dissipates heat accumulated in the heat shield 46B, suppressing temperature increase of the heat shield 46B effectively. Accordingly, the heat shield 46B suppresses generation of the fine particles. The reflector 48A contacts the thermal equalizer 45a contacting the fixing belt 42. Hence, as the temperature of the heat shield 46B increases, heat flows into the thermal equalizer 45a having a temperature lower than the temperature of the heat shield 46B. Thus, the thermal equalizer 45a suppresses temperature increase of the heat shield 46B. A thermal conductivity of the reflector 48A is greater than a thermal conductivity of the heat shield 46B, facilitating flowing of heat into the reflector 48A. Thus, the reflector 48A suppresses temperature increase of the heat shield 46B, suppressing generation of the fine particles.

A description is provided of a construction of a fixing device 40C according to yet another embodiment of the present disclosure.

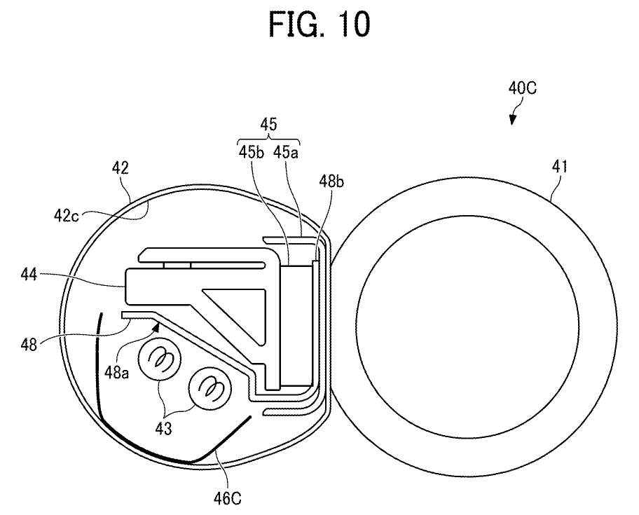

FIG. 10 is a cross-sectional view of the fixing device 40C according to the yet another embodiment of the present disclosure. FIG. 10 illustrates components of the fixing device 40C seen in the axial direction of the fixing belt 42. In order to clarify the description of the construction of the fixing device 40C, FIG. 10 omits illustration of the flange 47.

As illustrated in FIG. 10, the fixing device 40C according to the embodiment includes a heat shield 46C that is different from the heat shield 46 depicted in FIG. 2 in that the inner circumferential face 42c of the fixing belt 42 contacts and slides over the heat shield 46C.

With the construction of the fixing device 40C described above, in a case that the temperature of the heat shield 46C increases and is higher than a temperature of the fixing belt 42, the heat shield 46C contacting the fixing belt 42 dissipates heat accumulated in the heat shield 46C to the fixing belt 42. Thus, the heat shield 46C suppresses temperature increase thereof effectively, suppressing generation of the fine particles.

A description is provided of a construction of a fixing device 40D according to yet another embodiment of the present disclosure.

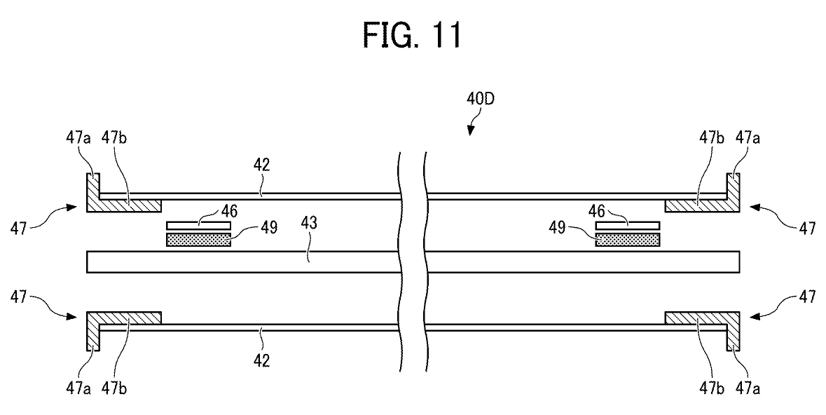

FIG. 11 is a diagram of the fixing device 40D according to the yet another embodiment of the present disclosure. FIG. 11 illustrates components of the fixing device 40D seen in the direction perpendicular to the axial direction of the fixing belt 42. In order to clarify the description of the construction of the fixing device 40D, FIG. 11 illustrates the single heater 43 depicted in FIG. 2 and omits illustration of the fixing stay 44, the nip formation pad 45, and the reflector 48.

As illustrated in FIG. 11, the fixing device 40D according to the embodiment is different from the fixing device 40 depicted in FIG. 4 in that the fixing device 40D includes a thermal insulator 49. The thermal insulator 49 may be a general thermal insulator that inhibits conduction of heat. The thermal insulator 49 is interposed between the heat shield 46 and the heater 43.

The fine particles generate in an increased amount when the heat shield 46 receives radiant heat from the heater 43 and suffers from temperature increase. Heat is conducted from the heat shield 46 to the flange 47 through air, increasing the temperature of the flange 47.

According to the embodiment, the thermal insulator 49 is interposed between the heat shield 46 and the heater 43. The thermal insulator 49 suppresses conduction of radiant heat from the heater 43 to the heat shield 46, suppressing temperature increase of the heat shield 46. Accordingly, in the fixing device 40D according to the embodiment also, the heat shield 46 suppresses generation of the fine particles.

The technology of the present disclosure is not limited to the embodiments described above. For example, the components of the fixing devices 40, 40A, 40B, 40C, and 40D may be combined with other elements and components. The embodiments of the present disclosure are modified or applied within the scope of the present disclosure and defined properly according to modification or application.

A description is provided of aspects of the embodiments of the present disclosure.

A description is provided of a first aspect of the embodiments of the present disclosure.

As illustrated in FIGS. 2 and 4, a fixing device (e.g., the fixing devices 40, 40A, 40B, 40C, and 40D) includes a fixing sleeve (e.g., the fixing belt 42), a support flange (e.g., the flange 47), a heater (e.g., the heater 43), a pressure rotator (e.g., the pressure roller 41), a heat shield (e.g., the heat shields 46, 46A, 46B, and 46C), a reflector (e.g., the reflectors 48 and 48A), and a slide aid (e.g., the thermal equalizer 45a).

The support flange rotatably supports or holds the fixing sleeve. The support flange supports a lateral end of the fixing sleeve in an axial direction thereof. The support flange is applied with a lubricant between the support flange and the fixing sleeve. The heater is disposed within the fixing sleeve and radiates heat. The pressure rotator is disposed opposite an outer circumferential face (e.g., the outer circumferential face 42b) of the fixing sleeve. The pressure rotator applies pressure to a recording medium (e.g., the sheet P) conveyed through a nip (e.g., the fixing nip N) formed between the pressure rotator and the outer circumferential face of the fixing sleeve.

The heat shield is disposed in proximity to the lateral end of the fixing sleeve in the axial direction thereof and interposed between the fixing sleeve and the heater. The reflector reflects heat radiated from the heater toward an inner circumferential face (e.g., the inner circumferential face 42c) of the fixing sleeve. The slide aid contacts the reflector and the inner circumferential face of the fixing sleeve that slides over the slide aid.

The heat shield includes an outermost edge (e.g., the outermost edge 46a) that is disposed in proximity to the lateral end of the fixing sleeve in the axial direction thereof. The support flange includes an innermost edge (e.g., the innermost edge 47c) that is oriented to a center of the fixing sleeve in the axial direction thereof. The outermost edge of the heat shield is disposed inboard from the innermost edge of the support flange in the axial direction of the fixing sleeve.

Accordingly, the fixing device incorporating the heater that heats the fixing sleeve suppresses temperature increase of the support flange that supports the lateral end of the fixing sleeve in the axial direction thereof effectively.

A description is provided of a second aspect of the embodiments of the present disclosure.

According to the first aspect of the fixing device, a thermal conductivity of the reflector is greater than a thermal conductivity of the heat shield.

A description is provided of a third aspect of the embodiments of the present disclosure.

As illustrated in FIG. 9, according to the first aspect of the fixing device, the heat shield contacts the reflector.

A description is provided of a fourth aspect of the embodiments of the present disclosure.

As illustrated in FIG. 8, according to the first aspect of the fixing device, the innermost edge of the support flange defines a hypothetical extension line (e.g., the extension line EL) that extends from the innermost edge in the axial direction of the fixing sleeve. The heat shield includes a slope (e.g., the slope 46b) that defines a clearance (e.g., the clearance W3) between the slope and the hypothetical extension line in a direction perpendicular to the axial direction of the fixing sleeve. The clearance increases toward the lateral end of the fixing sleeve in the axial direction thereof.

A description is provided of a fifth aspect of the embodiments of the present disclosure.

As illustrated in FIG. 10, according to the first aspect of the fixing device, the inner circumferential face of the fixing sleeve contacts and slides over the heat shield.

A description is provided of a sixth aspect of the embodiments of the present disclosure.

As illustrated in FIG. 11, the fixing device according to the first aspect further includes a thermal insulator (e.g., the thermal insulator 49) that is interposed between the heat shield and the heater.

A description is provided of a seventh aspect of the embodiments of the present disclosure.

As illustrated in FIG. 1, an image forming apparatus (e.g., the image forming apparatus 1) includes the fixing device according to any one of the first aspect to the sixth aspect.

According to the embodiments described above, the pressure roller 41 serves as a pressure rotator. Alternatively, the pressure rotator may be a pressure belt or the like. The image forming apparatus 1 is a printer. Alternatively, the image forming apparatus 1 may be a copier, a facsimile machine, a multifunction peripheral (MFP) having at least two of copying, printing, scanning, facsimile, and plotter functions, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a fixing belt to rotate;
a flange supporting a lateral end of the fixing belt in an axial direction of the fixing belt, the flange applied with a lubricant between the flange and the fixing belt, the flange having an innermost edge that is oriented to a center of the fixing belt in the axial direction of the fixing belt;
a heater disposed within the fixing belt, the heater to radiate heat; and
a heat shield disposed in proximity to the lateral end of the fixing belt in the axial direction of the fixing belt and interposed between the fixing belt and the heater,
the heat shield having an outermost edge disposed in proximity to the lateral end of the fixing belt in the axial direction of the fixing belt, the outermost edge disposed inboard from the innermost edge of the flange in the axial direction of the fixing belt.

2. The fixing device according to claim 1,
wherein the fixing belt includes a fixing sleeve.

3. The fixing device according to claim 1, further comprising a pressure rotator disposed opposite an outer circumferential face of the fixing belt to form a nip between the pressure rotator and the outer circumferential face of the fixing belt, the pressure rotator to apply pressure to a recording medium conveyed through the nip.

4. The fixing device according to claim 3,
wherein the pressure rotator includes a pressure roller.

5. The fixing device according to claim 1, further comprising a reflector to reflect the heat radiated from the heater toward an inner circumferential face of the fixing belt.

6. The fixing device according to claim 5, further comprising a slide aid contacting the reflector and the inner circumferential face of the fixing belt that slides over the slide aid.

7. The fixing device according to claim 5,
wherein a thermal conductivity of the reflector is greater than a thermal conductivity of the heat shield.

8. The fixing device according to claim 5,
wherein the heat shield contacts the reflector.

9. The fixing device according to claim 1,
wherein the innermost edge of the flange defines a hypothetical extension line that extends from the innermost edge in the axial direction of the fixing belt, and
wherein the heat shield includes a slope defining a clearance between the slope and the hypothetical extension line in a direction perpendicular to the axial direction of the fixing belt, the clearance increasing toward the lateral end of the fixing belt in the axial direction of the fixing belt.

10. The fixing device according to claim 9,
wherein the heat shield has a right-angled triangle shape.

11. The fixing device according to claim 1,
wherein the fixing belt has an inner circumferential face contacting the heat shield, the inner circumferential face to slide over the heat shield.

12. The fixing device according to claim 1, further comprising a thermal insulator interposed between the heat shield and the heater.

13. An image forming apparatus comprising:
an image forming device to form an image; and
a fixing device to fix the image on a recording medium,
the fixing device including:
a fixing belt to rotate;
a flange supporting a lateral end of the fixing belt in an axial direction of the fixing belt, the flange applied with a lubricant between the flange and the fixing belt, the flange having an innermost edge that is oriented to a center of the fixing belt in the axial direction of the fixing belt;
a heater disposed within the fixing belt, the heater to radiate heat; and
a heat shield disposed in proximity to the lateral end of the fixing belt in the axial direction of the fixing belt and interposed between the fixing belt and the heater,
the heat shield having an outermost edge disposed in proximity to the lateral end of the fixing belt in the axial direction of the fixing belt, the outermost edge disposed inboard from the innermost edge of the flange in the axial direction of the fixing belt.
